(19) United States
(12) Patent Application Publication
(10) Pub. No.: US 2007/0063968 A1
(43) Pub. Date: Mar. 22, 2007

(54) Portable communication device

(76) Inventor: Bodil Veige, Molle (SE)

Correspondence Address: MYERS BIGEL SIBLEY & SAJOVEC, P.A., P.O. BOX 37428, RALEIGH, NC, 27627, US

(21) Appl. No.: 11/230,443

(22) Filed: Sep. 20, 2005

(51) Int. Cl. G09G 5/00

(52) U.S. Cl. 345/156

(57) ABSTRACT

A portable communication device includes first and second parts, a user input device, and a control unit. The second part is rotatably coupled through a hinge to an end of the first part and configured to be positioned relative to the first part in at least one open position and one closed position. At least one of the first and second parts includes an information presentation unit that is configured to present a first list of items stored in the device for viewing by a user when the second part is in the closed position. The first list includes at least a first item and one or more further items corresponding to the at least first item. The user input device is configured to sense a user selection of a displayed item. The control unit is configured to respond to user selection sensed by the user input device of an item from the first list of items by displaying a second list comprising letters, and to respond to user selection among the displayed letters by modifying the displayed first list of items.

### FIELD OF THE INVENTION

The present invention relates to the field of handling a list of information for a portable communication device and more particularly to handling such information for a foldable portable communication device with a hinge.

### BACKGROUND OF THE INVENTION

There is a trend within the field of portable communicating devices, and especially within the field of cellular phones of foldable devices, for instance of so-called “clam-shell” or foldable “knife” type, which have two parts rotatably connected via a hinge to each other. A typical clam-shell phone is described for instance in U.S. Pat. No. 6,097,339.

Moreover, portable communication devices such as cellular phones are normally provided with a built-in contact list, a so called phone book, in which a number of contact persons and their corresponding phone numbers or e-mail addresses are stored, and in which a user can find a particular contact for instance by scrolling through the lists or entering a letter or a name by means of input from a key-board, whereby a contact starting with that letter or name appears in a list.

To make a call or send a message to one or more contacts in the list, the entire list, or part of it is displayed to the user on a display, whereby the desired contact can be selected from the list, and then the call can be initiated or the message sent.

In a foldable portable communication device such as a clam-shell or foldable knife-type cellular phone, the user either has to open the clam to be able to use the key-board located inside the housing of the phone for finding a contact in the contact list, or if he/she does not open the phone, manually has to scroll the contact list, typically displayed in a display located on the outside of the housing, which in many cases is very inconvenient for the user for instance because it is time-consuming if the list contains many contacts.

There is therefore a need for providing an alternative way of finding a contact also when clam is closed without using the conventional key-board located inside the housing or scroll through a long list.

### SUMMARY OF THE INVENTION

Some embodiments of the present invention are directed towards solving a problem associated with providing a way of finding a contact in device with a closed clam-shell housing and without using the conventional key-board, or scrolling the list manually.

Some embodiments of the present invention provide a foldable portable communication device having two parts joined to each other by a hinge and including a user friendly searchable list of items, such a contact list that does not require opening of the clam.

According to a first embodiment of the present invention, a portable communication device is adapted to select an item, such as a number or address, from a first list of items, such as a contact list, stored in the device, for instance for initiating a call or sending a message from the device to said number or address. The list includes at least a first item and one or more further items, such as names and one or more numbers and/or addresses corresponding to the at least first item. The device includes first and second parts, a user input device, and a control unit. The second part is rotatably coupled through a hinge to an end of the first part and configured to be positioned relative to the first part in at least one open position and one closed position. The first or second part includes an information presentation unit configured to display the list of items while in a closed position of the communication device. The communication device depending on user-input is further arranged to display a second list that includes letters. The displayed letter are selectable by user-input sensed by the user input device. The control unit is configured to respond to user selection sensed by the user input device of an item from the first list of items by displaying a second list that includes letters, and to respond to user selection among the displayed letters by modifying the displayed first list of items.

In this way, some embodiments of the invention enable the user to find an item such as a contact when the communication device is closed, such as by using a multi letter search.

A second embodiment of the present invention is directed towards a portable communication device that includes at least some of the features of the first embodiment, wherein the user input device is a navigation device that can be actuated by a user selection relative to at least two directions, for allowing the second list selection action by the user.

A third embodiment of the present invention is directed towards a portable communication device that includes the features of the first or second embodiments, and the control unit is configured to display the second list on the information presentation unit, to respond to selection by a user among the second list as sensed by the user input device by modifying the first list of items.

A fourth embodiment of the present invention is directed towards a portable communication device including the features of any one of the previous embodiments, wherein the selectable letters are arranged as multi-tab keys in rows.

A fifth embodiment of the present invention is directed towards a portable communication device including the features of the second embodiment, wherein the navigation device controls location of a cursor displayed on the information presentation unit for selecting among the letters, the cursor highlighting a letter and the control unit is configured to modify the first list of items after an elapsed time of a letter being highlighted so that the first list of items displays the first item with a name starting with the highlighted letter.

A sixth embodiment of the present invention is directed towards a portable communication device including the features of the first to the fifth embodiments, wherein the navigation device includes four keys that can be actuated to indicate user selections along up, down, left and right directions along the information presentation unit.

A seventh embodiment of the present invention is directed towards a portable communication device including the features of the first to the fifth embodiments, wherein the navigation device is provided in a volume settings button of the device.

An eight embodiment of the present invention is directed towards a portable communication device according to any one of the previous embodiments, in which the communication device comprises a mobile phone.

A ninth embodiment of the present invention is directed toward a method for selecting an item from a list of items displayed on a foldable portable communication device that can be moved between an open position and a closed position. A first list of items is displayed on the communication device for viewing by a user when the communication device is in the closed position. The first list of items includes at least a first item and one or more further items corresponding to the at least first item. A second list is displayed responsive to a user selection of the first item from the first list of items, the second list includes letters. The displayed first list of items is modified responsive to a user selection among the displayed letters.

A tenth embodiment of the present invention is directed toward the method of the ninth embodiment, and further includes modifying the first list of items responsive to a focus selection of one of the displayed letters. The selected one of the displayed letters is saved. A further item is selected corresponding to the selected first item. The second list of letters is removed from display after a defined time has elapsed.

Accordingly, in some embodiments, a user may find an item, such as a contact when the clam-shell housing of the communication device is closed.

### BRIEF DESCRIPTION OF THE DRAWINGS

The present invention will now be described in more detail in relation to the enclosed drawings, in which:

FIG. 1 schematically shows a perspective view of a clam-shell phone according to some embodiments of the invention in a closed position, in which a first part of the phone comprises a display for presenting a contact list in the closed position

FIG. 2 shows a schematic block diagram of some components of the phone in FIG. 1; and

FIG. 3 shows a flowchart of methods according to some embodiments of the present invention.

### DETAILED DESCRIPTION OF EMBODIMENTS

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art.

It will be understood that, as used herein, the singular forms “a”, “an” and “the” are intended to include the plural forms as well, unless the context clearly indicates otherwise. It also will be understood that, as used herein, the term “comprising” or “comprises” is open-ended, and includes one or more stated elements, steps and/or functions without precluding one or more unstated elements, steps and/or functions. The term “and/or” includes any and all combinations of one or more of the associated listed items.

It will also be understood that when an element is referred to as being “connected” to another element, it can be directly connected to the other element or intervening elements may be present. In contrast, when an element is referred to as being “directly connected” to another element, there are no intervening elements present. It will also be understood that the sizes and relative orientations of the illustrated elements are not shown to scale, and in some instances they have been exaggerated for purposes of explanation. Like numbers refer to like elements throughout.

Embodiments according to the present invention are described with reference to block diagrams and/or operational illustrations of methods, wireless communication terminals, and computer program products. It is to be understood that each block of the block diagrams and/or operational illustrations, and combinations of blocks in the block diagrams and/or operational illustrations, can be implemented by radio frequency, analog and/or digital hardware, and/or computer program instructions. Computer program instructions may be provided to a processor circuit of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational block or blocks.

A foldable portable communication device according to some embodiments of the present invention will now be described in relation to a foldable cellular phone. The phone is may be configured as a so-called foldable knife or clamshell phone. The portable communication device can be another type of foldable portable communication device though, like a foldable cordless phone, a communication module, a PDA or any other type of foldable portable device communicating with radio waves.

In the exemplary embodiments, selection of an item in the form of a contact from a contact list will be described. However, it is to be understood that the invention is not limited to selection of contacts, and may instead be applied to all types of selectable items such as a music etc.

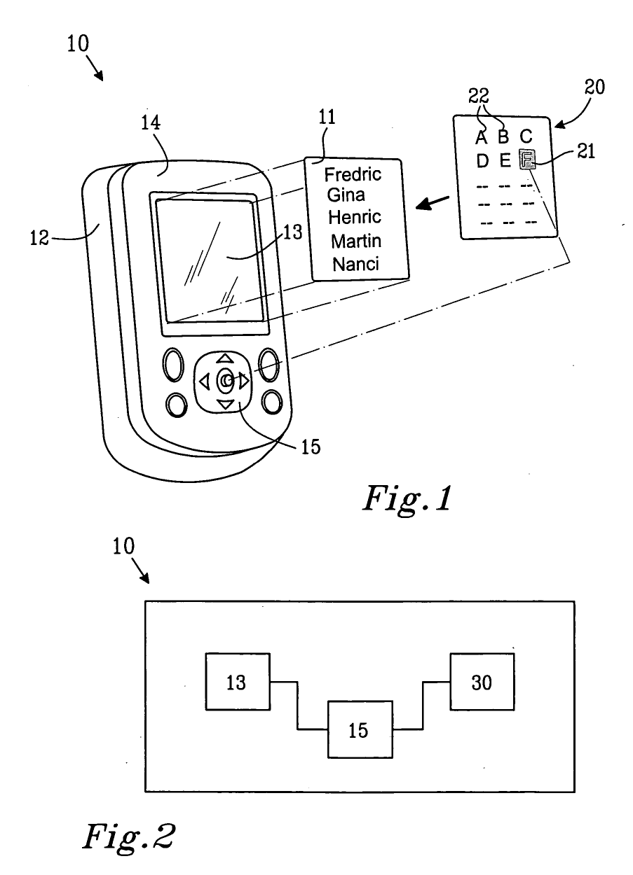

FIG. 1 schematically shows a perspective view of a clamshell phone according to some embodiments of the invention. The phone 10 includes a first and a second part 12 and 14, where the second part 14 can be rotated around (rotationally coupled to) the end of the first part 12. In the figure, the phone is shown in a closed position, in which the second part 14 is provided with an information presentation unit 13, here a display, to which in the following will be referred, for presenting a contact list 11 in the closed position. The phone 10 further comprises a navigation device 15, here in the form of four separate navigation keys, of which typically two keys are employed, for selecting a particular contact from the contact list 11. The navigation device 15 embodied as the four separate keys can be activated corresponding to the four directions up, down, left and right, but it can be alternatively arranged as a joy stick or combined in for instance a joy stick and one or more separate additional key(s). Alternatively, the navigation device 15 could be implemented comprising software for control, for instance implemented as a set of soft-keys, per se operating in a well known way. The navigation device 15 is typically provided on the side of the phone as an additional key, but can alternatively be implemented in the button normally used for volume settings.

The display 13, per se of conventional type, is typically arranged for presenting further information such as telephone numbers, address information, different indications from the phone, text messages received from another phone etc. To better illustrate the invention, the display 13 is shown covering a larger area of the first part 12, than typically in reality, i.e. the dimensions of different elements are not to scale. However, the area of the display 13 is not limited to any particular area, but should of course be large enough to operate properly such that relevant contact information can be displayed in an efficient and user friendly way.

FIG. 2 schematically illustrates a schematic block diagram of some components of the phone 10 according to some embodiments. The display 13, the user input 15 are here shown as separate boxes connected to a control unit 30.

The control unit is normally provided in the form of one or more processors with corresponding program memories containing suitable software code. The control unit is furthermore connected to a storage 40, preferably provided in the form of a memory.

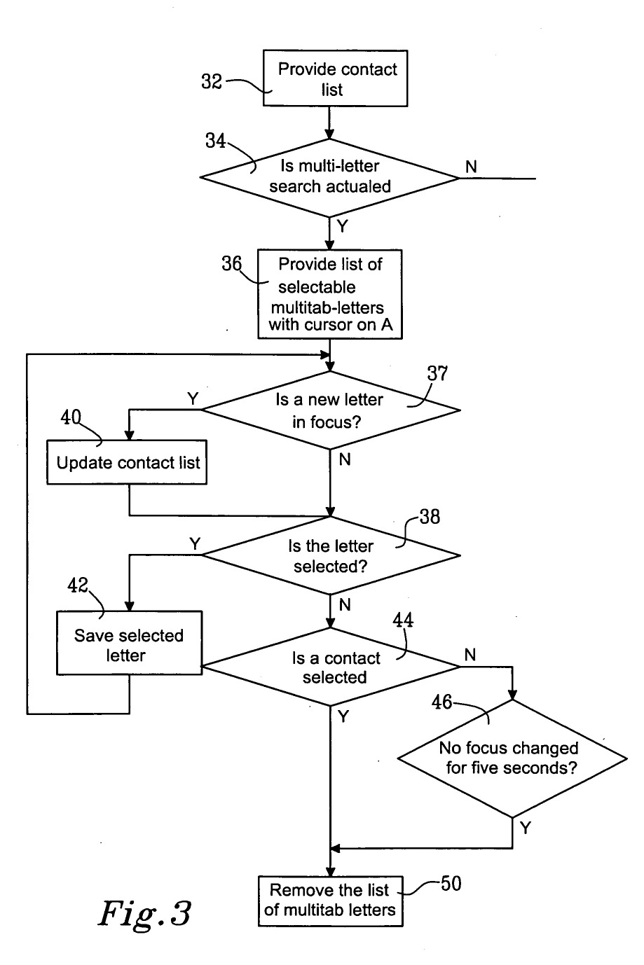

FIG. 3 illustrates a flow chart of a method according to some embodiments of the present invention.

Exemplary embodiments of the invention will now be explained with reference to FIG. 1, 2 and 3.

Below, to start, a typical use of the contact list 11 in the phone 10 will be explained and related to the invention.

A user that wants to make a call or send a message, or just check an address to a contact (for instance a person's address), whose number and/or address is stored in the phone 10 as a phone book has to activate the phone 10 in some way, for instance by means of operating the navigation device 15.

That is because, normally, if the phone 10 has not been in use for a while, for instance no call or message has been sent or received, or the phone has not been activated in some other way, the display 13 is normally “turned off” operating in some type of stand-by mode, typically having the display light turned off, or screen-saver activated, typically to save battery power.

This is not further described or illustrated since there are other ways a user can activate the display 13 which will be apparent to one skilled in the art in view of the description herein. Thus, it is understood that FIG. 1 illustrates a situation after the display 13 has been activated in a way known per se.

Here, FIG. 1 schematically shows a contact list 11 in the form of an “open” phone book containing contacts and their corresponding telephone numbers, which can be selected. The way the phone book is illustrated is by no means intended to specifically show the appearance of the contact list 11, but is merely intended to explain the invention in an easy and understandable way. Thus, the appearance of the contact list could be any suitable appearance, and is by no means limited to what is shown or described in relation to the specific embodiment disclosed and shown in relation to any of the drawing figures.

Moreover, the step to provide (select) the contact list 11 is not shown (except in FIG. 3, step 32), but may be carried out by means of an icon that can be activated (selected), for instance by means of the navigation device 15, or in another way that will be apparent to one skilled in the art in view of the description herein, for instance by means of clicking on soft-keys from a toolbar placed directly over the soft keys. Thus, since FIG. 1 shows the contact list 11 in the form of an open phone book, it is assumed that the contact list 11 has already been selected or activated in some way, for instance by having selected an icon intended to illustrate a “phone book”, typically in the form of an icon that can be selected once highlighted and surrounded by a frame and the corresponding function “phone book” is shown at the top of the display (not shown).

FIG. 1 schematically shows the contact list 11 and a second popup list 20 displayed in the display 13, after a selectable function, for instance denoted “find”, provided upon user-input to activate the contact list 11 such that the second popup list 20 has already been activated, (step 32 and step 34). This can be provided for instance by selecting the item “find” from a contact list menu displayed in some way after having selected the icon “phone book” as described in the previous paragraph. Important for the invention is that the function “find” is implemented. Of course, any other suitable appearance, i.e. not limited to a popup list, such as an icon looking like a magnifying glass could be provided instead of “find” as described above, provided the popup list is activated and displayed by proper user input when the user wants this inventive function.

The second popup list 20 is arranged as multi-tab letters 22, for instance ABCÅÄ on the first row, DEFE on the second row etc (of which only the two first rows are illustrated), of which one of the possible letters is highlighted and can be selected, step 37, typically by the navigation key 15, and if the possible key is not the intended one, another one can be highlighted and possibly selected as will be even further described below, step 38.

As soon as a (new) letter, here the letter F, is highlighted, preferably by means of a marking cursor 21, as illustrated in FIG. 1 by the navigation device 15, the contact list 11 will be updated, step 37, 40 (and 42), and focused on the first contact with a name starting with the letter in focus, i.e. in this case F. N. B., FIG. 1 illustrates the appearance of the contact list 11 before letter F has been selected. Typically, the phone 10 is arranged to update the contact list after a few seconds, step 46, the duration thereof is however preferably depending on user settings made earlier or depending on a default value, say 3 seconds.

If the user wants to find a contact among these “new” listed contacts (with names starting with the letter in focus), he/she has to validate his/her desire, step 44, after having entered a new letter in the same way as described above, or without entering anything, the user presses “OK”, for instance by pressing on a particular key, for instance the navigation key 15 again (which can be a soft-key). Preferably, a function denoted “check” is implemented in the phone for this, and the letter will be saved and shown in a title row in the second popup list 20. Next move of the cursor 21 will then find the first contact with a name starting with the combination of the saved letter and the new letter now in focus. When the right person is in focus a function preferably denoted “select” which is also implemented in the phone 10 will arrange the appearance display 13 such that the list of letters disappear, step 50.

It is possible that sub-lists comprising multiple telephone numbers to one and the same person are provided, whereby the user can also select which number he/she wants among these. In such a sub list it could also be possible to scroll through the numbers, for instance by means of the navigation device 15.

Once a contact has been selected a call could be initiated or a message sent in a conventional way.

Even if not particularly described above, alternative shortcuts, such as highlighting and selecting in one and the same step could also be implemented, preferably according to user settings of the phone. As an example, a long press, i.e. during a certain period of time, say five seconds could provide such an shortcut.

Various embodiments of the invention may be implemented at least partly within software, such as through a store and related processing unit(s).

As described above, some embodiments of the present invention may allow a user to find a contact when the phone is closed, i.e. the clam-shell is closed.

Embodiments of the present invention can be varied in many ways in addition to those described above. For example, the navigation device 15 may have more or less than the illustrated four buttons and/or may include a slideable button without departing from the invention. It is to be understood that the invention is not limited to the types or configuration of the illustrated buttons or keys, but can be used with any key provided on a phone. The invention is also not to be limited to the set of items described in relation to a contact list and phone numbers. Instead, embodiments of the invention may allow selection among any set of items, such as a list of received or sent messages, music, and/or a list of settings that can be made.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A portable communication device comprising:
a first part;
a second part rotatably coupled through a hinge to an end of the first part and configured to be positioned relative to the first part in at least one open position and one closed position, wherein at least one of the first and second parts comprise an information presentation unit that is configured to present a first list of items stored in the device for viewing by a user when the second part is in the closed position, the first list including at least a first item and one or more further items corresponding to the at least first item;
a user input device that is configured to sense a user selection of a displayed item; and
a control unit that is configured to respond to user selection sensed by the user input device of an item from the first list of items by displaying a second list comprising letters, and to respond to user selection among the displayed letters by modifying the displayed first list of items.

2. The portable communication device according to claim 1, wherein the user input device is a navigation device that can be actuated by a user selection relative to least two directions, and the control unit is configured to respond to actuation of the navigation device.

3. The portable communication device according to claim 1, wherein the control unit is further configured to display the second list on the information presentation unit, to respond to selection by a user among the second list as sensed by the user input device by modifying the first list of items.

4. The portable communication device according to claim 1, wherein the selectable letters of the second list are arranged as multi-tab keys in rows.

5. The portable communication device according to claim 2, wherein the navigation device controls location of a cursor displayed on the information presentation unit for selecting among the letters, the cursor highlighting a letter and the control unit is configured to modify the first list of items after an elapsed time of a letter being highlighted so that the first list of items displays the first item with a name starting with the highlighted letter.

6. The portable communication device according to claim 2, wherein the navigation device comprises four keys that can be actuated to indicate user selections along up, down, left and right directions along the information presentation unit.

7. The portable communication device according to claim 2, wherein the navigation device is provided in a volume settings button of the device.

8. The portable communication device according to claim 1, wherein the device comprises a mobile phone.

9. A method for selecting an item from a list of items displayed on a foldable portable communication device that can be moved between an open position and a closed position, the method comprising the steps of:
displaying a first list of items on the communication device for viewing by a user when the communication device is in the closed position, wherein the first list of items comprises at least a first item and one or more further items corresponding to the at least first item;
displaying a second list that comprises letters responsive to a user selection of the first item from the first list of items; and
modifying the displayed first list of items responsive to a user selection among the displayed letters.

10. The method of claim 9, further comprising:
modifying the first list of items responsive to a focus selection of one of the displayed letters;
saving the selected one of the displayed letters;
selecting a further item corresponding to the selected first item; and
removing the second list of letters from display after a defined time has elapsed.
